(19) United States
(12) Patent Application Publication
(10) Pub. No.: US 2026/0084237 A1
(43) Pub. Date: Mar. 26, 2026

(54) LASER CUTTING APPARATUS AND WAFER CUTTING METHOD

(71) Applicant: WUHAN XINXIN SEMICONDUCTOR MANUFACTURING CO., LTD., Wuhan (CN)

(72) Inventors: Yang PENG, Wuhan (CN); Bang CHEN, Wuhan (CN); Wanli GUO, Wuhan (CN)

(21) Appl. No.: 19/112,416

(22) PCT Filed: Dec. 30, 2022
(86) PCT No.: PCT/CN2022/137439

§ 371 Date: Mar. 17, 2025

(30) Foreign Application Priority Data
Oct. 11, 2022 (CN) 202211244108.6

(51) Int. Cl. B23K 26/06; B23K 26/046; B23K 26/0622; B23K 26/16; B23K 26/38; B23K 101/40

(52) U.S. Cl. CPC B23K 26/0604; B23K 26/046; B23K 26/0624; B23K 26/16; B23K 26/38; B23K 2101/40

(57) ABSTRACT

A laser cutting apparatus and a method for dicing a wafer. The laser cutting apparatus is used to cut a substrate retained on a support table and includes a laser. The substrate is disposed between the laser and the support table. The laser is adapted to emit first and second laser radiations so that the first laser radiation and the second radiation act on the substrate at different locations, a difference T between the time at which the second laser radiation acts on the substrate at the location and the time at which the first laser radiation acts on the substrate at the location is longer than or equal to 0. The first laser radiation is used to cut the substrate, and the second laser radiation is used to clear byproducts produced from the cutting of the substrate by the first laser radiation.

### TECHNICAL FIELD

The present invention relates to the field of semiconductor integrated circuit (IC) fabrication technology and, in particular, to a laser cutting apparatus and a method for dicing a wafer.

### BACKGROUND

Three-dimensional (3D) integrated circuit (IC) fabrication may involve bonding dies of different functionalities diced from complete wafers using a bonding technique. This enables a reduced chip area and an increased degree of integration. At present, such dicing is accomplished primarily by mechanical cutting, laser dicing and plasma etching. Among these approaches, plasma etching is most popular due to its wide range of advantages including fast processing, good post-etch healing and a high depth-to-width etch ratio (for a wafer thickness less than 100 μm). However, the materials of many layers in wafers, such as metals, low-k materials and oxides exposed in scribe lanes, are not suitable for processing by plasma etching, but can be easily ablated with laser radiation. Therefore, the use of plasma etching in combination with laser cutting for dicing a wafer typically requires the coating of a layer of a water-soluble liquid for protection against laser radiation to the wafer's surface to be processed. In this case, laser cutting can be applied to an insulating layer on a substrate in the wafer and a metal layer in the insulating layer, and plasma etching can be applied to the substrate.

Referring to FIG. 1 in a conventional laser cutting apparatus, a wafer 10 is placed on a support table 11, and a laser 12 is arranged above the wafer 10. A laser radiation L1 emitted from the laser 12 passes through a focusing unit 13 and is thereby focused onto a scribe lane (not shown) formed in the wafer 10 to cut an insulating layer and a metal layer in the insulating layer along the scribe lane. In this process, the laser radiation can instantaneously raise the temperature at the irradiated location of a surface of the wafer 10 over a vapor point of a material at the wafer surface, thereby vaporizing the material. However, the vaporized material may then cool and fall as dross. In addition, the heat applied in this process may create a thermal effect around the processed area, which may adversely affect its surface morphology. Both these problems will deteriorate surface flatness of the wafer 10 and therefore affect the subsequent bonding process.

Therefore, there remains an urgent need to improve the conventional laser cutting apparatus to ensure high cutting efficiency while obtaining improved post-cutting wafer surface flatness.

### SUMMARY

It is an objective of the present invention to provide a laser cutting apparatus and a method for dicing a wafer, which can ensure high cutting efficiency while obtaining improved post-cutting wafer surface flatness.

This object is attached by a laser cutting apparatus of the present invention for use to cut a substrate retained on a support table. The laser cutting apparatus includes:
a laser, which is separated from the support table by the substrate and adapted to emit a first laser radiation and a second laser radiation so that the first laser radiation acts on the substrate and that the second laser radiation acts on the substrate at a location at which the first laser radiation has acted, a difference T between the time at which the second laser radiation acts on the substrate at the location and the time at which the first laser radiation acts on the substrate at the location is longer than or equal to 0,
wherein the first laser radiation is used to cut the substrate, and the second laser radiation is used to clear byproducts produced from the cutting of the substrate by the first laser radiation.

Optionally, the first laser radiation may have a greater pulse width and a smaller range of action on the substrate than the second laser radiation, making the first laser radiation suitable for use to cut the substrate and making the second laser radiation suitable for use to clear the byproducts.

Optionally, the range of action of the second laser radiation on the substrate may be 1-7 μm larger than that of the first laser radiation.

Optionally, the laser cutting apparatus may include at least two lasers adapted to separately emit the first and second laser radiations.

Optionally, the first laser radiation may be emitted from a picosecond laser, and the second laser radiation may be emitted from a femtosecond laser.

Optionally, the laser cutting apparatus may include a focusing spectrometer, which is disposed between the substrate and the laser and adapted to adjust a horizontal distance between an emission path of the first laser radiation proximal to the substrate and an emission path of the second laser radiation proximal to the substrate.

Optionally, the laser cutting apparatus may include a focusing unit, which is disposed between the focusing spectrometer and the laser and adapted to focus the first and second laser radiations on the focusing spectrometer.

The present invention also provides a method for dicing a wafer, including:
providing a wafer retained on a support table;
providing a first laser radiation and a second laser radiation, wherein the first laser radiation acts on the wafer and the second laser radiation acts on the wafer at a location at which the first laser radiation has acted, a difference T between the time at which the second laser radiation acts on the wafer at the location and the time at which the first laser radiation acts on the wafer at the location is longer than or equal to 0,
wherein the first laser radiation is used to cut the wafer, and the second laser radiation is used to clear byproducts produced from the cutting of the wafer by the first laser radiation.

Optionally, the first laser radiation may have a greater pulse width and a smaller range of action on the wafer than the second laser radiation, making the first laser radiation suitable for use to cut the wafer and making the second laser radiation suitable for use to clear the byproducts.

Optionally, the first laser radiation may be a picosecond laser radiation, and the second laser radiation may be a femtosecond laser radiation.

Optionally, the wafer may include a substrate and a dielectric layer formed on the substrate and containing a conductive material, wherein the first and second laser radiations are used to cut the dielectric layer and the conductive material in the wafer, and an etching process is used to cut the substrate in the wafer.

The present invention provides the following benefits over the prior art:
1. It provides a laser cutting apparatus including a laser, which is separated from a support table by a substrate and adapted to emit a first laser radiation and a second laser radiation, the first laser radiation acts on the substrate and the second laser radiation acts on the substrate at a location at which the first laser radiation has acted, with a difference T between the time at which the second laser radiation acts on the substrate at the location and the time at which the first laser radiation acts on the substrate at the location being longer than or equal to 0, wherein the first laser radiation is used to cut the substrate, and the second laser radiation is used to clear byproducts produced from the cutting of the substrate by the first laser radiation. This can not only ensure high cutting efficiency, but can also improve post-cutting substrate surface flatness.
2. It provides a method for dicing a wafer, in which first and second laser radiations are provided. The first laser radiation acts on the wafer and the second laser radiation acts on the wafer at a location at which the first laser radiation has acted, with a difference T between the time at which the second laser radiation acts on the wafer at the location and the time at which the first laser radiation acts on the wafer at the location being longer than or equal to 0. The first laser radiation is used to cut the wafer, and the second laser radiation is used to clear byproducts produced from the cutting of the wafer by the first laser radiation. This can not only ensure high cutting efficiency, but can also improve post-cutting wafer surface flatness.

### BRIEF DESCRIPTION OF THE DRAWINGS

FIG. 1 is a schematic illustration of a laser cutting apparatus.

FIG. 2 is a schematic illustration of a laser cutting apparatus according to an embodiment of the present invention.

FIG. 3 is a flowchart of a method for dicing a wafer according to an embodiment of the present invention.

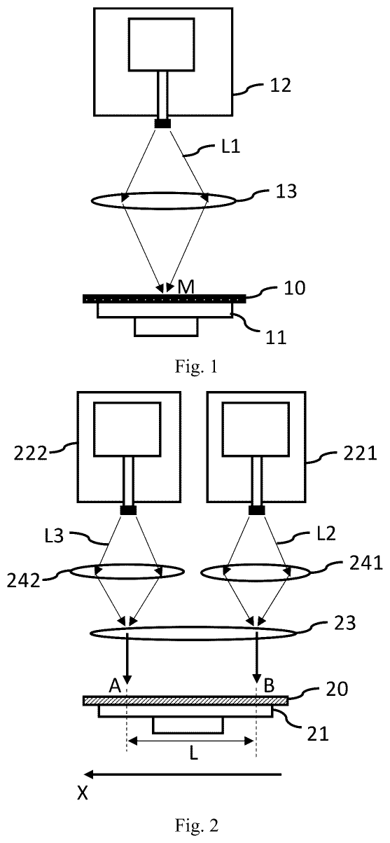

In FIGS. 1 to 3,

10 denotes a wafer; 11, a support table; 12, a laser; 20, a substrate; 21, a support table; 221, a picosecond laser; 222, a femtosecond laser; 23, a focusing spectrometer; 241, a first focusing unit; 242, a second focusing unit.

### DETAILED DESCRIPTION

Objectives, features and advantages of the present invention will become more apparent upon reading the following detailed description of a laser cutting apparatus and a method for dicing a wafer proposed herein in conjunction with the accompanying drawings. Note that the figures are provided in a very simplified form not necessarily drawn to exact scale for the only purpose of helping explain the disclosed embodiments in a more convenient and clearer way.

An embodiment of the present invention provides a laser cutting apparatus for cutting a substrate retained on a support table. The laser cutting apparatus includes: a laser separated from the support table by the substrate, the laser adapted to emit a first laser radiation and a second laser radiation so that the first laser radiation acts on the substrate and that the second laser radiation acts on the substrate at a location at which the first laser radiation has acted, a difference T between the time at which the second laser radiation acts on the substrate at the location and the time at which the first laser radiation acts on the substrate at the location is longer than or equal to 0, wherein the first laser radiation is used to cut the substrate, and the second laser radiation is used to clear byproducts produced from the cutting of the substrate by the first laser radiation.

A more detailed description of the laser cutting apparatus of this embodiment is set forth below.

The support table has a support surface facing toward the laser, and the substrate is retained on the support surface of the support table and thus located between the laser and the support table.

The substrate may be retained on the support table by a suction member and/or a clamping member provided on the support table.

The substrate may be a glass substrate, a ceramic substrate, a wafer or any other substrate known to those skilled in the art. Preferably, the substrate is a wafer including a substrate and a dielectric layer on the substrate. The dielectric layer contains a conductive material. The wafer includes a plurality of die regions and scribe lanes joined between adjacent die regions. Individual dies can be obtained by dicing the wafer along the scribe lanes.

The first laser radiation has a greater pulse width than the second laser radiation. The first laser radiation has a smaller range of action on the substrate than the second laser radiation. With this arrangement, the first laser radiation can be used to cut the substrate, and the second laser radiation can be used to clear byproducts produced from the cutting of the substrate using the first laser radiation.

When interacting with a material, a laser radiation exerts a thermal effect thereon, and the magnitude of the thermal effect is closely related to a pulse width of the laser radiation. For example, when a laser radiation acts on a material, electrons therein will be excited by absorbing energy of the radiation and then transfer the energy to crystal lattices in the material through electron-lattice scattering. This process takes place within a time frame of tens of picoseconds. After that, heat is transferred from lattice to lattice, raising the temperature of surrounding lattices and eventually causing melting and vaporization of the material accompanied by phase changes. A nanosecond laser-radiation has a pulse width much longer than a time required for electron-lattice scattering to take place. When such a pulse acts on a material, there will be enough time for its energy to be transferred from electrons to crystal lattices and then from lattice to lattice in the material, ramping up the temperature of the lattices and eventually causing melting and vaporization of the material. In contrast, a femtosecond laser radiation has a pulse width much shorter than the electron-lattice scattering time. Consequently, even at the end of irradiation of such a laser pulse on a material, crystal lattices in the material will remain “cold” because there is not enough time for its energy to be transferred to the lattices. A femtosecond laser may cause dissociation of a material within several picoseconds. A picosecond laser radiation lies between nanosecond and femtosecond laser radiations in terms of pulse width and magnitude of a thermal effect that it exerts on a material during its interaction therewith.

The pulse width of the first laser radiation is longer than a time required for electron-lattice scattering to take place in the substrate and is therefore used to cut the substrate. As a result of cutting the substrate using the first laser radiation, deep grooves are formed in the substrate to ensure high cutting efficiency. However, due to high energy of the laser radiation, it exerts a significant thermal effect, which may lead to the generation of various byproducts on the treated surface of the substrate at and around the grooves. These byproducts may be dross and raised edges above the grooves.

The pulse width of the second laser radiation is shorter than the time required for electron-lattice scattering to take place in the substrate and is therefore essentially not used to further cut the substrate, in order to avoid additional accumulation of such byproducts. Instead, the second laser radiation is configured with a larger range of action on the substrate than the first laser radiation and used to melt and vaporize the various byproducts produced from the cutting of the substrate using the first laser radiation on the substrate surface at and around the grooves. This enables the substrate surface to have increased post-cutting flatness.

Using first laser radiation to cut the substrate and using the second laser radiation to clear the byproducts produced from the cutting of the substrate by the first laser radiation may be accomplished in many ways. An emission path of the first laser radiation proximal to the substrate is horizontally spaced from an emission path of the second laser radiation proximal to the substrate at a distance L, which is greater or equal to a predetermined distance. The predetermined distance is configured so that a location at which the second laser radiation acts on the substrate encompasses or overlaps a location at which the first laser radiation acts on the substrate. When L is equal to the predetermined distance, a location at which the second laser radiation acts on the substrate encompasses or overlaps a location at which the first laser radiation acts on the substrate. When L is greater than the predetermined distance, a location at which the second laser radiation acts on the substrate neither encompasses nor overlaps a location at which the first laser radiation acts on the substrate. Preferably, the range of action of the second laser radiation on the substrate is 1-7 μm greater than the range of action of the first laser radiation on the substrate.

When the difference T between the time at which the second laser radiation acts on the substrate at a location and the time at which the first laser radiation acts on the substrate at the location is equal to 0, the first and second laser radiations simultaneously act on the same location of the substrate. When L is equal to the predetermined distance, at the same time as the first laser radiation cuts the substrate, the second laser radiation clears byproducts produced from the cutting of the substrate by the first laser radiation.

When the difference T between the time at which the second laser radiation acts on the substrate at a location and the time at which the first laser radiation acts on the substrate at the location is greater than 0, after the first laser radiation acts on the substrate, the second laser radiation acts on the substrate at the same location as the first laser radiation. That is, there is a lag between the times at which the second and first laser radiations act on the substrate at the same location. L may be equal to or greater than the predetermined distance. In one embodiment, L is equal to the predetermined distance, and the first and second laser radiations act on a single location within both their ranges of action. The first laser radiation may be emitted at an earlier time and the second laser radiation may be emitted at a later time so that the second laser radiation acts on the substrate after the first laser radiation has acted on the substrate. The first and second laser radiations may be successively and alternately emitted in the form of pulses at time intervals. Every time after the first laser radiation acts on the substrate at a certain point, the substrate may be held stationary, and the second laser radiation may be emitted within an interval between the current and next emissions of the first laser radiation so that the second laser radiation acts on the substrate also at said point (i.e., at a single point on the substrate, such point M of FIG. 1, in this embodiment). In this embodiment, after the first and second laser radiations complete the cutting and byproduct clearing tasks by successively acting on the substrate (at point M), the substrate is moved to the next location to receive the next cutting action. In another embodiment, L is greater than the predetermined distance, and any single point on the substrate is not both within the ranges of action of the first and second laser radiations. In this case, the first and second laser radiations may be simultaneously emitted so that, after the first laser radiation acts on the substrate, the second laser radiation acts on the substrate at the same location as the first laser radiation acted at. After the first laser radiation acts on the substrate at a certain point (e.g., point A of FIG. 2 on the substrate, in this embodiment), the substrate is moved away from the next point of action (e.g., point B of FIG. 2, in this embodiment), and when said point on the substrate (point A) enters the range of action of the second laser radiation, and the second laser radiation is emitted to clear byproducts produced at said point (point A) from the cutting of the substrate by the first laser radiation.

After the first laser radiation acts on the substrate, the second laser radiation acts on the substrate at the same location(s) as the first laser radiation acted at. A cycle is defined as that after the first laser radiation acts on the substrate, and the second laser radiation then acts on the substrate. In each cycle, the first laser radiation may act on the substrate x times, and the second laser radiation may act on the substrate y times. Such a cycle may be repeated N times, and x≥1, y≥1 and N≥1, where x, y and N are all integers. This cycle is repeated until cutting of the substrate is completed. In this way, as the substrate is being cut, byproducts on the substrate can be cleared to deburr and clean the substrate surface around the scribe lanes and prevent accumulation of such byproducts during cutting, resulting in improved post-cutting substrate surface flatness.

In one embodiment, x=1, y=1 and N=1. In this case, in step S21, the first laser radiation performs a single cutting action on the substrate. Next, in step S22, the second laser radiation acts on the substrate once to clear byproducts produced from the cutting action performed on the substrate by the first laser radiation. Thus, cutting of the substrate and clearing of byproducts thereon are completed. In another embodiment, x=1, y=1 and N=2. In this case, in step S21, the first laser radiation performs a single cutting action on the substrate. Next, in step S22, the second laser radiation acts on the substrate once to clear byproducts produced from the cutting action performed on the substrate by the first laser radiation. At last, steps S21 and S22 are repeated once to complete cutting of the substrate and clearing of byproducts thereon. In yet another embodiment, x=2, y=3 and N=3. In this case, in step S21, the first laser radiation performs two cutting actions on the substrate. Next, in step S22, the second laser radiation acts trice to clear byproducts produced from the cutting actions performed on the substrate by the first laser radiation. At last, steps S21 and S22 are repeated trice to complete cutting of the substrate and clearing of byproducts thereon.

Preferably, the horizontal distance L at which the emission path of the first laser radiation proximal to the substrate is spaced from the emission path of the second laser radiation proximal to the substrate is greater than the predetermined distance, and the substrate is moved in a direction from each point of action on the substrate away from the next point of action on the substrate. In step S21, the first laser radiation performs x cutting actions on the substrate in the direction from each point of action on the substrate away from the next point of action on the substrate. In step S22, the second laser radiation acts y times in the direction from each point of action on the substrate away from the next point of action on the substrate to clear byproducts produced from the cutting actions performed on the substrate by the first laser radiation. Steps S21 and S22 are then repeated (N−1) times to complete cutting of the substrate and clearing of byproducts thereon.

Either a single laser or at least two lasers may be included. When there is only one laser, it may successively and alternately, or simultaneously, emit the first and second laser radiations. When at least two lasers are included, they may separately emit the first and second laser radiations. They may successively and alternately emit the first and second laser radiations. Alternatively, they may simultaneously emit the first laser radiation and/or the second laser radiation at horizontal intervals.

At least two of a nanosecond laser, a picosecond laser and a femtosecond laser may be included. A pulse width of the nanosecond laser may be shorter than a pulse width of the picosecond laser, which may be in turn shorter than a pulse width of the femtosecond laser. That is, the nanosecond and picosecond lasers may be used to emit nanosecond and picosecond laser radiations, respectively, to cut the substrate. Alternatively, the nanosecond and femtosecond lasers may be used to emit nanosecond and femtosecond laser radiations, respectively, to cut the substrate and clear byproducts therefrom. Still alternatively, the picosecond and femtosecond lasers may be used to emit picosecond and femtosecond laser radiations, respectively, to cut the substrate and clear byproducts therefrom. Yet still alternatively, the nanosecond, picosecond and femtosecond lasers may be used to emit nanosecond, picosecond and femtosecond laser radiations, respectively, to cut the substrate and clear byproducts therefrom. Preferably, the first laser radiation is emitted from the picosecond laser, and the second laser radiation is emitted from the femtosecond laser.

Among the nanosecond, picosecond and femtosecond lasers, the nanosecond laser emits a laser radiation with the longest pulse width, which can not only create a deep groove in the substrate, but can even cut through the substrate. The picosecond laser lies between the femtosecond and nanosecond lasers in terms of pulse width and cutting power. Since the first laser radiation has a pulse width that is longer than the time required for electron-lattice scattering to take place in the substrate and is therefore suitable to cut the substrate, as noted above, it may be emitted either from the nanosecond laser, or from the picosecond laser.

As the femtosecond laser emits a laser radiation with a pulse width shorter than the electron-lattice scattering time in the substrate, when the laser radiation acts on the substrate, it will essentially not deepen a groove that has been formed in the substrate, but will vaporize dross on the inner surface of the groove and on the substrate surface around the groove and raised edges above the groove. Therefore, it is suitable for use to remove byproducts on inner surfaces of such grooves and on the substrate surface around the grooves and can provide better substrate surface cleaning. For this reason, the second laser radiation for clearing byproducts produced from cutting of the substrate by the first laser radiation is preferably emitted from the femtosecond laser.

The laser cutting apparatus may further include a focusing spectrometer disposed between the substrate and the laser, the focusing spectrometer is adapted to adjust the horizontal distance between the emission paths of the first and second laser radiations proximal to the substrate. Moving the focusing spectrometer toward the laser can increase the horizontal distance between the emission paths of the first and second laser radiations proximal to the substrate. On the contrary, moving the focusing spectrometer toward the substrate can reduce the horizontal distance between the emission paths of the first and second laser radiations proximal to the substrate.

In case of significant generation of dross and raised edges from cutting using the first laser radiation emitted from the laser, the horizontal distance between the emission paths of the second and first laser radiations emitted from the laser proximal to the substrate may be decreased to allow quicker removal of the dross and raised edges by the second laser radiation, avoiding further accumulation of such dross and raised edges.

The focusing spectrometer may include a lens and lens retention means.

The laser cutting apparatus may further include a focusing unit disposed between the focusing spectrometer and the laser, the focusing unit is adapted to separately focus the first and second laser radiations from the laser on the focusing spectrometer. Moreover, the focusing spectrometer may be able to separately refocus the incident first and second laser radiations. In this way, the first and second laser radiations incident on the substrate are more focused and can cut the substrate with higher positional accuracy.

The focusing unit may include a lens and lens retention means.

When immediately emitted from the laser, the first and second laser radiations may be essentially parallel to each other, or not. However, after passing through and exiting the focusing spectrometer, the first and second laser radiations are always incident on the substrate as parallel beams. This enables the first and second laser radiations from the laser to follow consistent paths to cut the substrate, avoiding any cutting deviations.

In the embodiment of FIG. 2, two lasers are arranged above the substrate 20 on the support table 21. These may be a picosecond laser 221 and a femtosecond laser 222, the picosecond laser 221 and the femtosecond laser 222 are spaced apart from each other. The first laser radiation L2 may be emitted from the picosecond laser 221, focused by the first focusing unit 241 and incident on the focusing spectrometer 23. After exiting the focusing spectrometer 23, it may be incident on the substrate 20. The second laser radiation L3 may be emitted from the femtosecond laser 222, focused by the second focusing unit 242 and incident on the focusing spectrometer 23. After exiting the focusing spectrometer 23, it may be incident on the substrate 20. When the substrate 20 is a wafer, the first laser radiation L2 and the second laser radiation L3 may be incident on a single scribe lane in the substrate 20. The first laser radiation L2 may first act on a point on the substrate 20 (e.g., point A), and the second laser radiation L3 may then act on the same point on the substrate 20 (e.g., point A). The emission path of the first laser radiation L2 proximal to the substrate is horizontally (e.g., in direction X, as shown) spaced from the emission path of the second laser radiation L3 proximal to the substrate at a distance L greater than the predetermined distance. During cutting, after the first laser radiation L2 acts on the substrate 20 at a point (e.g., point A), the support table 21 may be moved in direction X to displace the substrate 20 from said point on the substrate 20 (point A) away from the next point of action on the substrate (e.g., point B). When said point on the substrate 20 (point A) enters the range of action of the second laser radiation L3, the second laser radiation L3 is emitted to clear any possible byproducts produced from the cutting action of the first laser radiation L2 performed on the point on the substrate 20 (point A). In this way, the first laser radiation L2 first performs cutting actions along the scribe lane, and the second laser radiation L3 then follows the same path as the first laser radiation L2 to perform its intended task.

Therefore, the present invention provides a laser cutting apparatus including a laser, which is separated from a support table by a substrate and adapted to emit a first laser radiation and a second laser radiation so that the first laser radiation acts on the substrate and that the second laser radiation acts on the substrate at a location at which the first laser radiation has acted, a difference T between the time at which the second laser radiation acts on the substrate at the location and the time at which the first laser radiation acts on the substrate at the location is longer than or equal to 0, wherein the first laser radiation is used to cut the substrate, and the second laser radiation is used to clear byproducts produced from the cutting of the substrate by the first laser radiation. This can not only ensure high cutting efficiency, but can also improve post-cutting substrate surface flatness.

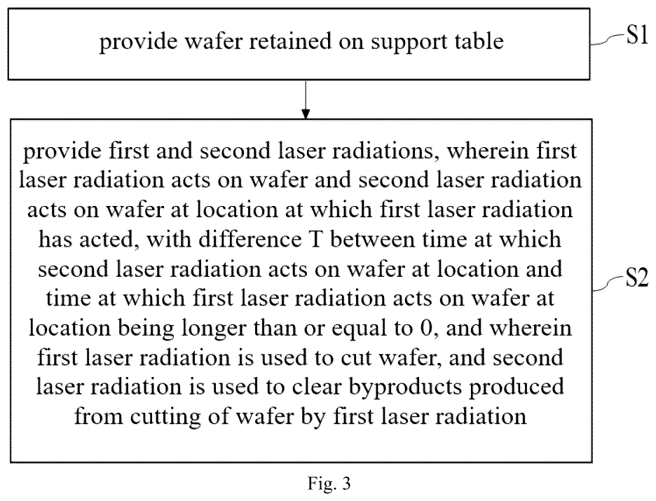

An embodiment of the present invention provides a method for dicing a wafer. Referring to FIG. 3, the method includes:
in step S1, providing a wafer retained on a support table;
in step S2, providing a first laser radiation and a second laser radiation, wherein the first laser radiation acts on the wafer and the second laser radiation acts on the wafer at a location at which the first laser radiation has acted, a difference T between the time at which the second laser radiation acts on the wafer at the location and the time at which the first laser radiation acts on the wafer at the location is longer than or equal to 0, and wherein the first laser radiation is used to cut the wafer, and the second laser radiation is used to clear byproducts produced from the cutting of the wafer by the first laser radiation.

A more detailed description of the method of this embodiment is set forth below.

In step S1, a wafer is provided, which is retained on a support table.

The support table has a support surface facing toward a laser, and the wafer is retained on the support surface of the support table and thus located between the laser and the support table. For more details of the laser, reference is made to the above description in connection with the laser cutting apparatus, and further description thereof is omitted here.

When the wafer is being cut, the laser is held stationary, while the support table is moved horizontally to approach the laser.

The wafer may include a substrate and a dielectric layer on the substrate. The dielectric layer may contain a conductive material. The wafer may include a plurality of die regions and scribe lanes joined between adjacent die regions. Individual dies can be obtained by dicing the wafer along the scribe lanes.

In step S2, a first laser radiation and a second laser radiation are provided. The first laser radiation acts on the wafer and the second laser radiation acts on the wafer at a location at which the first laser radiation has acted, a difference T between the time at which the second laser radiation acts on the wafer at the location and the time at which the first laser radiation acts on the wafer at the location is longer than or equal to 0. The first laser radiation is used to cut the wafer, and the second laser radiation is used to clear byproducts produced from the cutting of the wafer by the first laser radiation.

The first laser radiation has a greater pulse width than the second laser radiation. The first laser radiation has a smaller range of action on the wafer than the second laser radiation. With this arrangement, the first laser radiation can be used to cut the wafer, and the second laser radiation can be used to clear byproducts produced from the cutting of the wafer using the first laser radiation.

Using first laser radiation to cut the wafer and using the second laser radiation to clear the byproducts produced from the cutting of the wafer by the first laser radiation may be accomplished in many ways. An emission path of the first laser radiation proximal to the wafer is horizontally spaced from an emission path of the second laser radiation proximal to the wafer at a distance L, which is greater or equal to a predetermined distance. The predetermined distance is configured so that a location at which the second laser radiation acts on the wafer encompasses or overlaps a location at which the first laser radiation acts on the wafer. When L is equal to the predetermined distance, a location at which the second laser radiation acts on the wafer encompasses or overlaps a location at which the first laser radiation acts on the wafer. When L is greater than the predetermined distance, a location at which the second laser radiation acts on the wafer neither encompasses nor overlaps a location at which the first laser radiation acts on the wafer. Preferably, the range of action of the second laser radiation on the wafer is 1-7 μm greater than the range of action of the first laser radiation on the wafer.

When the difference T between the time at which the second laser radiation acts on the wafer at a location and the time at which the first laser radiation acts on the wafer at the location is equal to 0, the first and second laser radiations simultaneously act on the same location of the wafer. When L is equal to the predetermined distance, at the same time as the first laser radiation cuts the wafer, the second laser radiation clears byproducts produced from the cutting of the wafer by the first laser radiation.

When the difference T between the time at which the second laser radiation acts on the wafer at a location and the time at which the first laser radiation acts on the wafer at the location is greater than 0, after the first laser radiation acts on the wafer, the second laser radiation acts on the wafer at the same location as the first laser radiation. That is, there is a lag between the times at which the second and first laser radiations act on the wafer at the same location. L may be equal to or greater than the predetermined distance. In one embodiment, L is equal to the predetermined distance, and the first and second laser radiations act on a single location within both their ranges of action. The first laser radiation may be emitted at an earlier time and the second laser radiation may be emitted at a later time so that the second laser radiation acts on the wafer after the first laser radiation has acted on the wafer. The first and second laser radiations may be successively and alternately emitted in the form of pulses at time intervals. Every time after the first laser radiation acts on the wafer at a certain point, the wafer may be held stationary, and the second laser radiation may be emitted within an interval between the current and next emissions of the first laser radiation so that the second laser radiation acts on the wafer also at said point (i.e., at a single point on the wafer, such point M of FIG. 1, in this embodiment). In this embodiment, after the first and second laser radiations complete the cutting and byproduct clearing tasks by successively acting on the wafer (at point M), the wafer is moved to the next location to receive the next cutting action. In another embodiment, L is greater than the predetermined distance, and any single point on the wafer is not both within the ranges of action of the first and second laser radiations. In this case, the first and second laser radiations may be simultaneously emitted so that, after the first laser radiation acts on the wafer, the second laser radiation acts on the wafer at the same location as the first laser radiation acted at. After the first laser radiation acts on the wafer at a certain point (e.g., point A of FIG. 2 on the wafer, in this embodiment), the wafer is moved away from the next point of action (e.g., point B of FIG. 2, in this embodiment), and when said point on the wafer (point A) enters the range of action of the second laser radiation, and the second laser radiation is emitted to clear byproducts produced at said point (point A) from the cutting of the wafer by the first laser radiation.

After the first laser radiation acts on the wafer, the second laser radiation acts on the wafer at the same location or locations as the first laser radiation acted at. Within an interval between successive actions of the second laser radiation on the wafer, the first laser radiation may act x times on the wafer. Within an interval between successive actions of the first laser radiation on the wafer, the second laser radiation may act y times on the wafer. In each cycle, the first laser radiation acts on the wafer, and the second laser radiation then acts on the wafer. Such a cycle may be repeated N times, and x≥1, y≥1 and N≥1, where x, y and N are all integers. This cycle is repeated until cutting of the wafer is completed. In this way, as the wafer is being cut, byproducts on the wafer can be cleared to deburr and clean the wafer surface around the scribe lanes and prevent accumulation of such byproducts during cutting, resulting in improved post-cutting wafer surface flatness.

In one embodiment, x=1, y=1 and N=1. In this case, in step S21, the first laser radiation performs a single cutting action on the wafer. Next, in step S22, the second laser radiation acts on the wafer once to clear byproducts produced from the cutting action performed on the wafer by the first laser radiation. Thus, cutting of the wafer and clearing of byproducts thereon are completed. In another embodiment, x=1, y=1 and N=2. In this case, in step S21, the first laser radiation performs a single cutting action on the wafer. Next, in step S22, the second laser radiation acts on the wafer once to clear byproducts produced from the cutting action performed on the wafer by the first laser radiation. At last, steps S21 and S22 are repeated once to complete cutting of the wafer and clearing of byproducts thereon. In yet another embodiment, x=2, y=3 and N=3. In this case, in step S21, the first laser radiation performs two cutting actions on the wafer. Next, in step S22, the second laser radiation acts trice to clear byproducts produced from the cutting actions performed on the wafer by the first laser radiation. At last, steps S21 and S22 are repeated trice to complete cutting of the wafer and clearing of byproducts thereon.

Preferably, the horizontal distance L at which the emission path of the first laser radiation proximal to the wafer is spaced from the emission path of the second laser radiation proximal to the wafer is greater than the predetermined distance, and the wafer is moved in a direction from each point of action on the wafer away from the next point of action on the wafer. In step S21, the first laser radiation performs x cutting actions on the wafer in the direction from each point of action on the wafer away from the next point of action on the wafer. In step S22, the second laser radiation acts y times in the direction from each point of action on the wafer away from the next point of action on the wafer to clear byproducts produced from the cutting actions performed on the wafer by the first laser radiation. Steps S21 and S22 are then repeated (N−1) times to complete cutting of the wafer and clearing of byproducts thereon.

Preferably, the first laser radiation is a picosecond laser radiation, and the second laser radiation is a femtosecond laser radiation.

Among nanosecond, picosecond and femtosecond laser radiations, nanosecond laser radiation has the longest pulse width, and therefore can not only create a deep groove in the wafer, but can even cut through the wafer. Picosecond laser radiation lies between femtosecond and nanosecond laser radiations in terms of pulse width and cutting power. The pulse width of the first laser radiation is longer than the time required for electron-lattice scattering to take place in the wafer and is therefore suitable to cut the wafer. To this end, the first laser radiation may be a nanosecond or picosecond laser radiation.

The pulse width of the second laser radiation is shorter than the time required for electron-lattice scattering to take place in the wafer. Therefore, when the second laser radiation acts on the wafer, it will essentially not deepen a groove that has been formed in the wafer, but will vaporize dross on the inner surface of the groove and on the wafer surface around the groove and raised edges above the groove. Therefore, it is suitable for use to remove byproducts on inner surfaces of such grooves and on the wafer surface around the grooves and can provide better wafer surface cleaning. For this reason, the second laser radiation for clearing byproducts produced from cutting of the wafer by the first laser radiation is preferably a femtosecond laser radiation.

In order to dice the wafer along the scribe lanes, a picosecond laser radiation emitted from a picosecond laser may be used first to cut the dielectric layer and the conductive material along the scribe lanes, and a femtosecond laser radiation emitted from a femtosecond laser may be then used to clean the wafer surface. After that, a dry etching (e.g., plasma etching) or wet etching process may be performed to cut the substrate along the scribe lanes. Alternatively, a nanosecond laser radiation emitted from a nanosecond laser may be used first to cut the wafer along the scribe lanes, and a femtosecond laser radiation emitted from a femtosecond laser may be then used to clean the wafer surface. It is to be noted that the present invention is not limited to either of these method for cutting the wafer along the scribe lanes, and any method suitable for this purpose may be used, as required.

Further, when laser cutting and etching are used in combination to dice the wafer, before the dielectric layer and the conductive material are cut along the scribe lanes, the method may further include: coating the wafer surface with a protective layer, which can protect the other regions of the wafer (including the die regions) than the scribe lanes from being undesirably etched during the subsequent etching of the substrate along the scribe lanes. In addition, the protective layer can also protect the other regions of the wafer than the scribe lanes from being contaminated by dross produced during laser cutting.

The protective layer may be made of a water-soluble resin.

Therefore, the present invention provides a method for dicing a wafer, in which first and second laser radiations are provided. The first laser radiation acts on the wafer and the second laser radiation acts on the wafer at a location at which the first laser radiation has acted, a difference T between the time at which the second laser radiation acts on the wafer at the location and the time at which the first laser radiation acts on the wafer at the location is longer than or equal to 0. The first laser radiation is used to cut the wafer, and the second laser radiation is used to clear byproducts produced from the cutting of the wafer by the first laser radiation. This can not only ensure high cutting efficiency, but can also improve post-cutting wafer surface flatness.

The description presented above is merely that of a few preferred embodiments of the present invention and does not limit the scope thereof in any sense. Any and all changes and modifications made by those of ordinary skill in the art based on the above teachings fall within the scope as defined in the appended claims.

1. A laser cutting apparatus for use to cut a substrate retained on a support table, the laser cutting apparatus comprising:
a laser separated from the support table by the substrate, the laser being configured to emit a first laser radiation and a second laser radiation, the first laser radiation acting on the substrate and the second laser radiation acting on the substrate at a location at which the first laser radiation has acted, a difference T between the time at which the second laser radiation acts on the substrate at the location and the time at which the first laser radiation acts on the substrate at the location being longer than or equal to 0,
wherein the first laser radiation is used to cut the substrate, and the second laser radiation is used to clear byproducts produced from the cutting of the substrate by the first laser radiation.

2. The laser cutting apparatus of claim 1, wherein the first laser radiation has a pulse width greater than a pulse width of the second laser radiation, the first laser radiation has a range of action on the substrate smaller than a range of action of the second laser radiation on the substrate, such that the first laser radiation being adapted to cut the substrate and the second laser radiation being adapted to clear the byproducts.

3. The laser cutting apparatus of claim 2, wherein the range of action of the second laser radiation on the substrate is 1-7 μm larger than the range of action of the first laser radiation on the substrate.

4. The laser cutting apparatus of claim 1, comprising at least two lasers adapted to separately emit the first laser radiation and the second laser radiation.

5. The laser cutting apparatus of claim 4, wherein the first laser radiation is emitted from a picosecond laser and the second laser radiation is emitted from a femtosecond laser.

6. The laser cutting apparatus of claim 1, further comprising a focusing spectrometer disposed between the substrate and the laser, and the focusing spectrometer being adapted to adjust a horizontal distance between an emission path of the first laser radiation proximal to the substrate and an emission path of the second laser radiation proximal to the substrate.

7. The laser cutting apparatus of claim 6, further comprising a focusing unit disposed between the focusing spectrometer and the laser, and the focusing unit being adapted to focus the first laser radiation and the second laser radiation on the focusing spectrometer.

8. A method for dicing a wafer, comprising:
providing a wafer retained on a support table;
providing a first laser radiation and a second laser radiation, wherein the first laser radiation acts on the wafer and the second laser radiation acts on the wafer at a location at which the first laser radiation has acted, a difference T between the time at which the second laser radiation acts on the wafer at the location and the time at which the first laser radiation acts on the wafer at the location being longer than or equal to 0,
wherein the first laser radiation is used to cut the wafer, and the second laser radiation is used to clear byproducts produced from the cutting of the wafer by the first laser radiation.

9. The method for dicing the wafer of claim 8, wherein the first laser radiation has a pulse width greater than a pulse width of the second laser radiation, the first laser radiation has a range of action on the substrate smaller than a range of action of the second laser radiation on the substrate, such that the first laser radiation being adapted to cut the substrate and the second laser radiation being adapted to clear the byproducts.

10. The method for dicing the wafer of claim 9, wherein the first laser radiation is a picosecond laser radiation and the second laser radiation is a femtosecond laser radiation.

11. The method for dicing the wafer of claim 8, wherein the wafer comprises a substrate and a dielectric layer formed on the substrate, the dielectric layer containing a conductive material, wherein the first laser radiation and the second laser radiation are used to cut the dielectric layer and the conductive material in the wafer, and an etching process is used to cut the substrate in the wafer.
